(19) United States
(12) Patent Application Publication
(10) Pub. No.: US 2026/0278871 A1
(43) Pub. Date: Sep. 17, 2026

(54) AI-BASED SYSTEM AND METHOD FOR MULTIMODAL ELEMENT-ORIENTED, LAYERED GRAPHIC DESIGN

(71) Applicant: Microsoft Technology Licensing, LLC, Redmond, WA (US)

(72) Inventors: Danqing HUANG, Mountain View, CA (US); Ji LI, San Jose, CA (US); Mingxi CHENG, San Jose, CA (US); Jiang BIAN, Fremont, CA (US); Shizhao SUN, Beijing (CN)

(73) Assignee: Microsoft Technology Licensing, LLC, Redmond, WA (US)

(21) Appl. No.: 19/077,348

(22) Filed: Mar. 12, 2025

(51) Int. Cl. G06T 11/60

(52) U.S. Cl. CPC G06T 11/60; G06T 2200/24

(57) ABSTRACT

A data processing system implements receiving a user request to lay out multimodal design elements in a graphic design; applying a first generative model to categorize the design elements based on their content attributes in an initial layer and at least two pre-defined layers; applying a second generative model to sequentially process the layers until rendering a final composition image, by: processing the initial layer into an initial image, and for each of the pre-defined layers: encoding content attributes of each design element of the layer and a precedent image into combined embeddings, projecting the combined embeddings to match a hidden state dimension, predicting position and size attributes per design element of the layer based on the combined embeddings, and rendering a composition image based on the position and size attributes; and displaying the final composition image.

### BACKGROUND

Artificial intelligence (AI) has the potential to automate our lives to save time and increase productivity. One area of interest is graphic design automation. Although there are diffusion design pipelines that integrate text-to-image technology and improve automatic design creation and variation, these pipelines primarily address visual element variation, and heavily depend on human-crafted templates for implicit layout guidance. It is a complex and time-consuming process to lay out multimodal design elements (such as images, headlines, decorative embellishments, and the like) in a graphic design (e.g., an invitation, a banner, a poster, and the like). A well-designed layout enhances the visual hierarchy, ensuring the design effectively communicates its intended message. The existing AI-based layout design approaches, such as content-aware layout generation, fail to consider all element content when creating a graphic design. Hence, there is a need for fast and comprehensive layout automation using AI that generates a comprehensive element-oriented, layered graphic design based on a given set of multimodal design elements.

### SUMMARY

An example data processing system according to the disclosure includes a processor and a machine-readable medium storing executable instructions. The instructions when executed cause the processor alone or in combination with other processors to perform operations including receiving, at a client device, a user request to lay out multimodal design elements in a graphic design; applying a first generative model to categorize each of the multimodal design elements based on content attributes of the multimodal design elements in a plurality of layers that are set in a predetermined order, wherein the layers include an initial layer, and at least two pre-defined layers; applying a second generative model to sequentially process the layers in the predetermined order until rendering a final composition image as the graphic design, by: applying a vision encoder to encode content attributes of each design element of the initial layer into initial content embeddings, applying a projector to project the initial content embeddings to match a hidden state dimension required by a backbone of the second generative model, applying the backbone to predict position and size attributes per design element of the initial layer based on the projected content embeddings, rendering an initial image by placing each design element of the initial layer onto the initial layer based on the position and size attributes predicted for each design element of the initial layer, for each of the pre-defined layers: applying the vision encoder to encode content attributes of each design element of the pre-defined layer and each design element of a precedent image into combined content embeddings, applying the projector to project the combined content embeddings to match the hidden state dimension required by the backbone, applying the backbone to predict position and size attributes per design element of the pre-defined layer based on the combined embeddings, and rendering a composition image by placing each design element of the pre-defined layer onto the pre-defined layer based on the position and size attributes predicted for each design element of the pre-defined layer, and overlaying the placed pre-defined layer upon the precedent image as the composition image, wherein the precedent image starts with the initial image; providing the final composition image to the client device; and causing a user interface of the client device to display the final composition image.

An example method implemented in a data processing system includes receiving, at a client device, a user request to lay out multimodal design elements in a graphic design; applying a first generative model to categorize each of the multimodal design elements based on content attributes of the multimodal design elements in a plurality of layers that are set in a predetermined order, wherein the layers include an initial layer, and at least two pre-defined layers; applying a second generative model to sequentially process the layers in the predetermined order until rendering a final composition image as the graphic design, by: applying a vision encoder to encode content attributes of each design element of the initial layer into initial content embeddings, applying a projector to project the initial content embeddings to match a hidden state dimension required by a backbone of the second generative model, applying the backbone to predict position and size attributes per design element of the initial layer based on the projected content embeddings, rendering an initial image by placing each design element of the initial layer onto the initial layer based on the position and size attributes predicted for each design element of the initial layer, for each of the pre-defined layers: applying the vision encoder to encode content attributes of each design element of the pre-defined layer and each design element of a precedent image into combined content embeddings, applying the projector to project the combined content embeddings to match the hidden state dimension required by the backbone, applying the backbone to predict position and size attributes per design element of the pre-defined layer based on the combined embeddings, and rendering a composition image by placing each design element of the pre-defined layer onto the pre-defined layer based on the position and size attributes predicted for each design element of the pre-defined layer, and overlaying the placed pre-defined layer upon the precedent image as the composition image, wherein the precedent image starts with the initial image; providing the final composition image to the client device; and causing a user interface of the client device to display the final composition image.

An example non-transitory computer readable medium data processing system according to the disclosure on which are stored instructions that, when executed, cause a programmable device to perform functions of receiving, at a client device, a user request to lay out multimodal design elements in a graphic design; applying a first generative model to categorize each of the multimodal design elements based on content attributes of the multimodal design elements in a plurality of layers that are set in a predetermined order, wherein the layers include an initial layer, and at least two pre-defined layers; applying a second generative model to sequentially process the layers in the predetermined order until rendering a final composition image as the graphic design, by: applying a vision encoder to encode content attributes of each design element of the initial layer into initial content embeddings, applying a projector to project the initial content embeddings to match a hidden state dimension required by a backbone of the second generative model, applying the backbone to predict position and size attributes per design element of the initial layer based on the projected content embeddings, rendering an initial image by placing each design element of the initial layer onto the initial layer based on the position and size attributes predicted for each design element of the initial layer, for each of the pre-defined layers: applying the vision encoder to encode content attributes of each design element of the pre-defined layer and each design element of a precedent image into combined content embeddings, applying the projector to project the combined content embeddings to match the hidden state dimension required by the backbone, applying the backbone to predict position and size attributes per design element of the pre-defined layer based on the combined embeddings, and rendering a composition image by placing each design element of the pre-defined layer onto the pre-defined layer based on the position and size attributes predicted for each design element of the pre-defined layer, and overlaying the placed pre-defined layer upon the precedent image as the composition image, wherein the precedent image starts with the initial image; providing the final composition image to the client device; and causing a user interface of the client device to display the final composition image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for AI-based multimodal element-oriented, layered graphic design are implemented.

FIGS. 2A-2C are conceptual diagrams of an AI-based multimodal element-oriented, layered graphic design pipeline of the system of FIG. 1 according to principles described herein.

FIGS. 3A-3E are diagrams of example user interfaces of an AI-based multimodal element-oriented, layered graphic design application that implements the techniques described herein.

FIG. 4 is a flow chart of an example process for AI-based multimodal element-oriented, layered graphic design according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for AI-based multimodal element-oriented, layered graphic design via layer planning and layer design composition are described herein. These techniques provide a technical solution to the technical problem of lack of fast and comprehensive AI-based multimodal element-oriented, layered graphic design systems and methods that automatically lay out a set of multimodal design elements into a graphic design. The existing AI-based graphic design systems automate many design tasks that were previously done manually, such as template generation, graphic creation prompt generation, and the like. Recently, diffusion-based text-to-image generation models have been applied to create artistic graphic designs based on a text input. While this text-to-image approach can provide impressive results, they cannot generate a comprehensive element-oriented, layered graphic design based on a given set of multimodal design elements.

As mentioned, to lay out multimodal design elements (such as images, headlines, and decorative embellishments) in a graphic design is a complex and time-consuming process that requires meticulous consideration of various factors. For instance, it is crucial to ensure that the main object is not obscured by other elements. In addition, text readability must be maintained by ensuring sufficient contrast between the text and its background. The existing AI-based layout design approaches, such as content-aware layout generation, do not consider all element content to create a complete graphic design. Content-aware layout generation is an emerging research topic that studies AI-based layout generation conditioned on a given canvas. The content-aware layout generation automatically arranges graphic elements on a given canvas while ensuring that the main object remains unobstructed. However, it typically only considers the background image content while overlooking the content of other elements. In addition, it does not predict text-related attributes during the layout generation process.

To address these issues, the proposed AI-based multimodal element-oriented, layered graphic design pipeline introduces a layer planning stage during which a multimodal generative model (e.g., LMM) categorizes the multimodal design elements based on their content attributes into different layers. For example, the layers include a background layer, an underlay layer, a core visual object layer, a text layer, and an embellishment layer, while the LMM is Generative Pre-Trained Transformer 4 (GPT-40), a multimodal LLM trained and created by OpenAI. Alternatively, the layer planning LMM can be DALL-E 2, Llama 3, ImageBind, LLaVA, Gemini, Florence, Claude, NVLM, and the like. The layer planning stage is followed by a layered design composition stage of the pipeline. During this composition stage, a layered design composition model sequentially processes each layer by predicting, per element of each layer, design element position and size attributes based on element content attributes of this layer as well as element content attributes of all of the precedent layers. The layered design composition model includes design composition LMMs sharing a model backbone. A composed image is rendered for this layer that incorporates content attributes of this layer and its precedent layers. As such, the final composed image incorporates content attributes of all of the layers. Therefore, the pipeline improves artistic graphic design generation by including the rendered image content of previously generated layers. The pipeline can be used in any systems, platforms, or applications (e.g., Microsoft Designer®, Create®, and the like).

In one implementation, to predict element position and size attributes, the layered design composition model applies a vision encoder to encode the element content attributes of the current layer and the element content attributes of the precedent layers as image embeddings. The layered design composition model then applies a projector to project these embeddings to match a hidden state dimension required by the model backbone (e.g., a LLM 126e). The model backbone is used to model a joint distribution across the layers, thereby ensuring cohesion in the layered design process.

A technical benefit of the approach provided herein is to consider all of the design element content attributes when laying out the design elements in the graphic design, which goes beyond simply placing all of given design elements in the graphic design.

Another technical benefit of this approach is to roll in element content attributes of earlier layers to provide better context for the layout in the next layer, as well as to increase the coherence of the final output.

Another technical benefit of this approach is to group related design elements into respective layers, and address them collectively per layer, thereby simplifying the design process. In addition, the layers are processed in a predetermined order to further increase design effectiveness and efficiency.

Another technical benefit of this approach is to display the layers to users for additional applications in graphic design, such as element editing, resolution adjustment, element filling, design suggestion/variation, resize and typography recommendations, and the like. The pipeline then regenerates a new output image based on user edits. As such, the pipeline outperforms models specialized in some design subtasks without any task-specific training.

Another technical benefit of the approach provided herein is to significantly improve the user experience in graphic design creation by simply dragging and dropping multimodal design elements without complicated text prompts, yet still create a comprehensive element-oriented, layered graphic design based on the multimodal design elements.

Yet another technical benefit of this approach is storing the comprehensive element-oriented, layered graphic designs and the respective design layers in the system, thereby saving the user significant time and effort in creating similar graphic designs in the future. These and other technical benefits of the techniques disclosed herein will be evident from the discussion of the example implementations that follow.

A “graphic design” refers to a specific style of digital content displayed on a page or on a computer screen. The graphic design can be used in stickers, greeting cards, collages, invitations, publication, email marketing templates, PowerPoint presentations, menus, social media ads, banners and graphics, marketing and advertising, packaging, visual identity, art and illustration graphic design, and the like.

The term “style” refers to the distinctive visual characteristics of a digital content item. These characteristics can include color palette, texture (e.g., brushstrokes), composition, layout, structure, scale, typography, level of details and abstraction, whitespace, overall mood, atmosphere, and the like. This definition is more flexible than some defined styles such as minimalist, retro, modern, or the like.

The term “multimodal design element” refers to text, core visual objects, audio or sound objects, haptic feedback, gestural interfaces (e.g., touch-based gestures on screens and motion-based inputs detected by sensors), interactive components (e.g., buttons, sliders, etc.), embellishments, and the like.

The term “core visual object” refers to any visual digital content item that captures the primary message of a graphic design. For example, a core visual object may be a logo that combines imagery, text, and/or audio elements. The visual digital content item can include graphics, symbols, icons, emoji, animated emoji, logos, raster images, vector images, 3D models, binary images, grayscale images, color images, pixel art, digital paintings, photos, diagrams, charts, infographics, videos, animations, screenshots, memes, slide decks, pictograms, ideograms, gaming interfaces, software application backgrounds, and the like.

The term “embellishment” refers to a decorative element, which when applied, increases the appeal of a graphic design, conveys a specific mood, or emphasizes particular aspects of the content. This element adds style to the design, without conveying core information.

Although various embodiments are described with respect to five layers including a background layer, a underlay layer, a core visual object layer, a text layer, and an embellishment layer, it is contemplated that the approach described herein may be used for other layers, such as a background layer, and at least two of a underlay layer, a core visual object layer, a text layer, an embellishment layer, an audio or sound object layer, a haptic feedback layer, a gestural interface layer, or an interactive component layer.

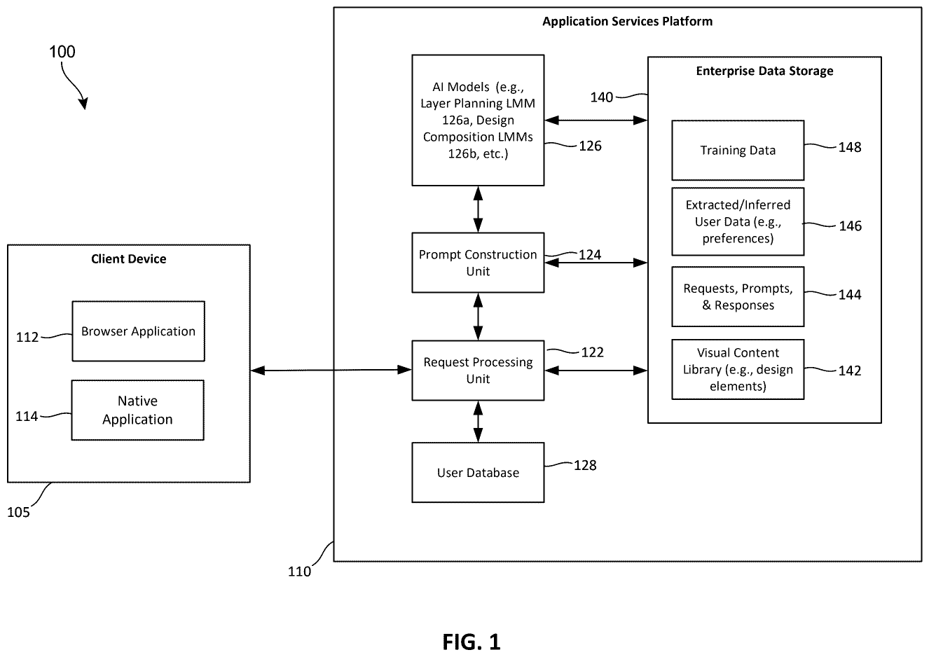

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to AI-based multimodal element-oriented, layered graphic design applications, presentation applications, website authoring applications, collaboration platforms, communications platforms, and/or other types of applications in which users may create, view, and/or edit various graphic designs based on a given set of multimodal design elements. In the implementation shown in FIG. 1, the application services platform 110 also applies generative AI to easily generate a comprehensive graphic design layout upon user demand according to the techniques described herein. The client device 105 and the application services platform 110 communicate with each other over a network (not shown). The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

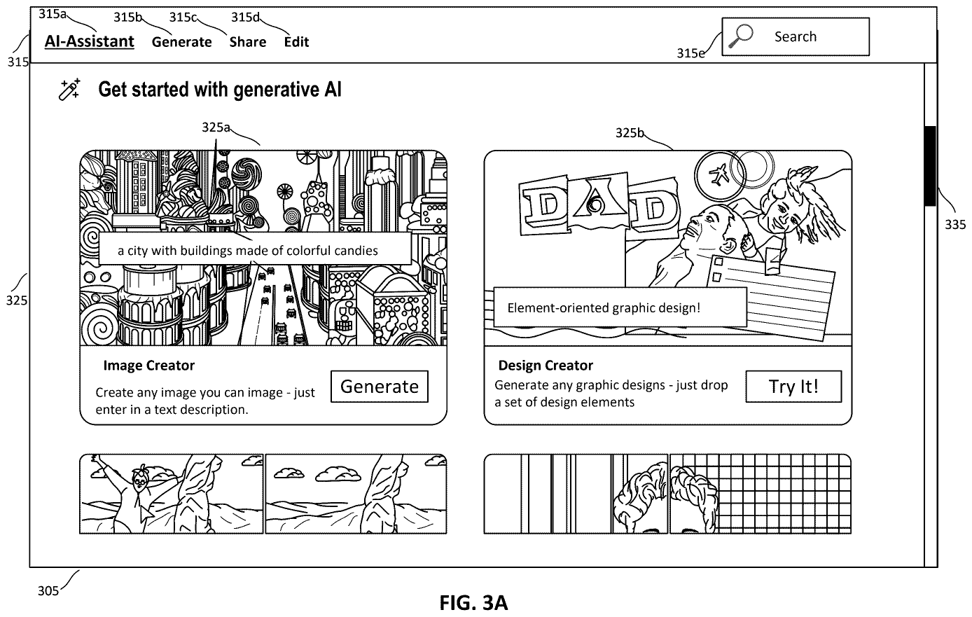

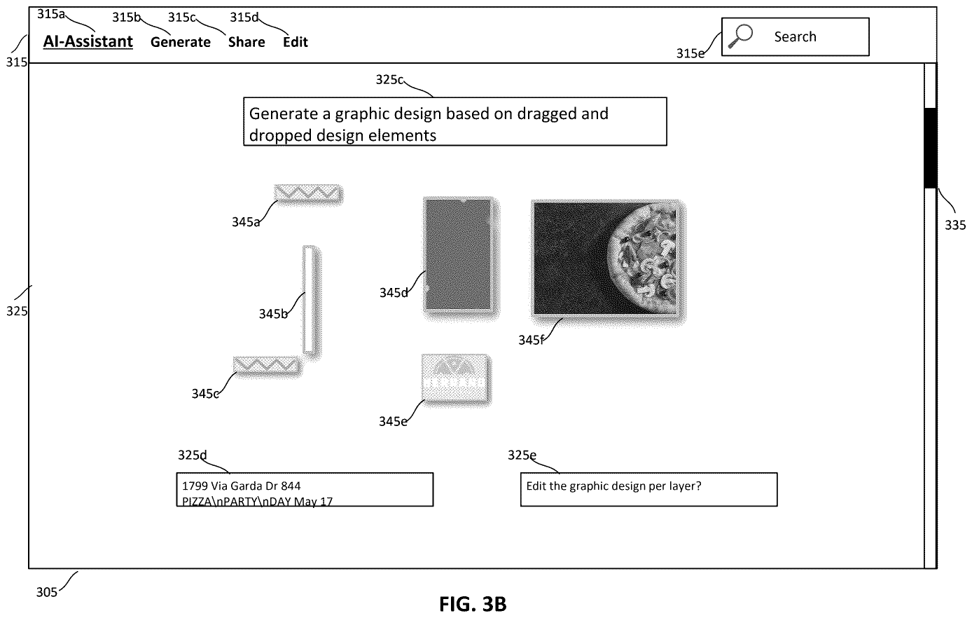

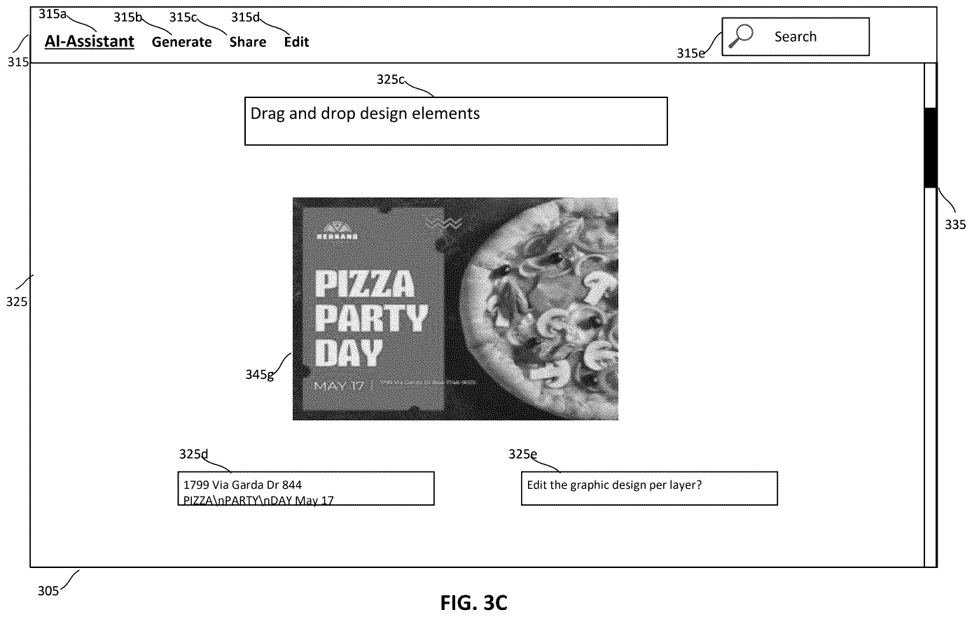

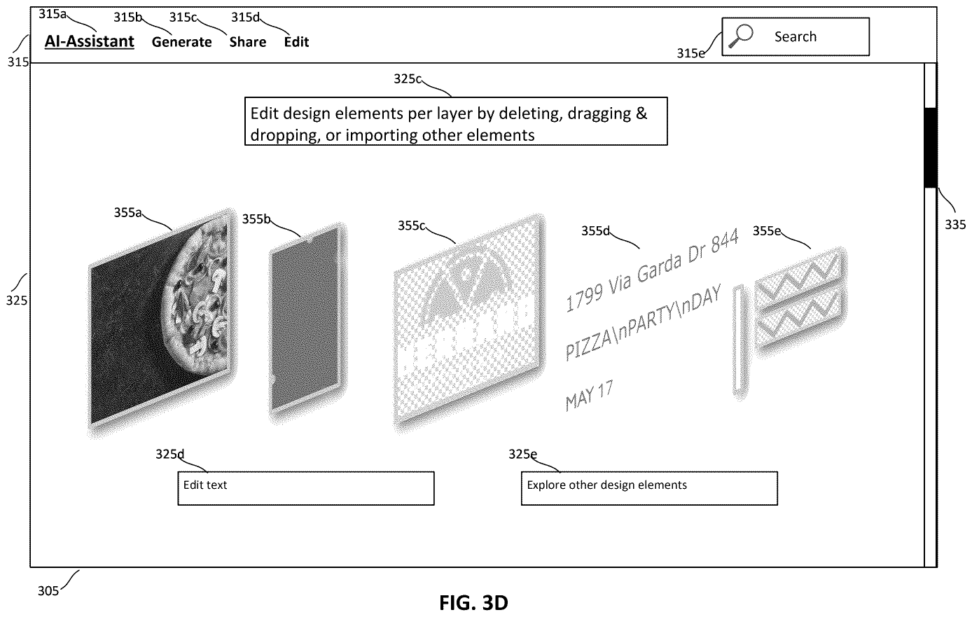

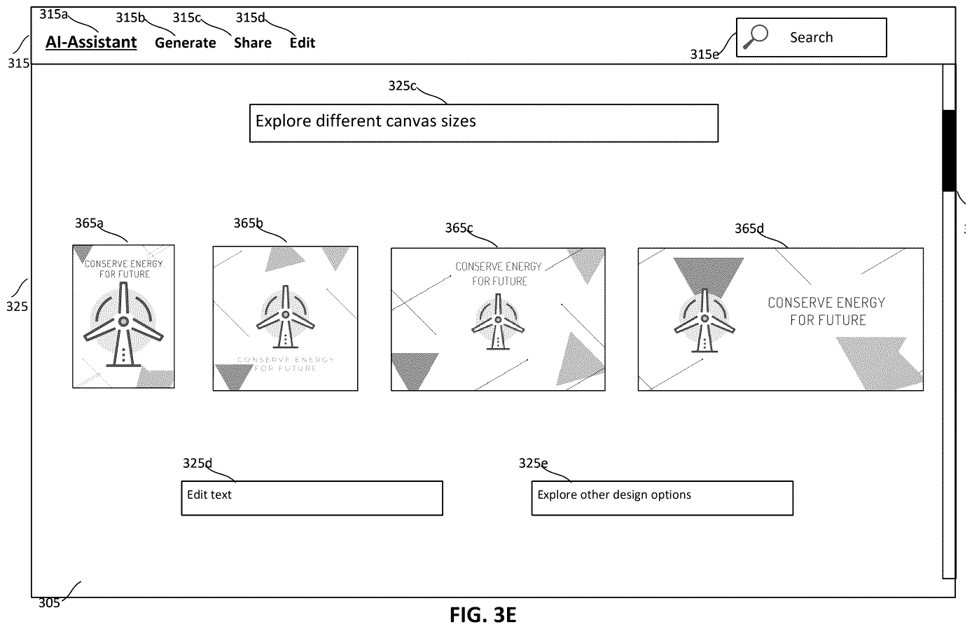

The client device 105 includes a native application 114 and a browser application 112. The native application 114 is a web-enabled native application, in some implementations, which enables a comprehensive element-oriented, layered graphic design based on a given set of multimodal design elements. The web-enabled native application utilizes services provided by the application services platform 110 including but not limited to creating, viewing, and/or editing various graphic designs based on a given set of multimodal design elements. The native application 114 implements a user interface 205 shown in FIGS. 3A-3E in some implementations. In other implementations, the browser application 112 is used for accessing and viewing web-based content provided by the application services platform 110. In such implementations, the application services platform 110 utilizes one or more web applications, such as the browser application 112, that enables users to create, view, and/or edit various graphic designs based on a given set of multimodal design elements using for example an online application. The browser application 112 implements the user interface 205 shown in FIGS. 3A-3E in some implementations. The application services platform 110 supports both the native application 114 and the browser application 112 in some implementations, and the users may choose which approach best suits their needs.

The application services platform 110 includes a request processing unit 122, a prompt construction unit 124, AI model(s) 126, a user database 128, and an enterprise data storage 140 that includes a content library 142, requests, prompts, and responses 144, extracted/inferred user data 146 (e.g., user preferences), training data 148, and the like. The request processing unit 122 is configured to receive requests from the native application 114 and/or the browser application 112 of the client device 105. The requests may include but are not limited to requests to create, view, and/or edit various graphic designs based on a given set of multimodal design elements according to the techniques provided herein.

The prompt construction unit 124 is responsible for creating and refining prompts to interact effectively with the AI model(s) 126. This involves designing input instructions that guide the AI model(s) 126 to produce accurate and contextually relevant outputs. The key tasks of the prompt construction unit 124 in the AI-based multimodal element-oriented, layered graphic design pipeline include constructing prompts to AI model(s) 126 (e.g., a layer planning LMM 126a) to categorize the multimodal design elements based on their content attributes into different layers, to predict, per element of each layer, design element position and size attributes based on element content attributes of this layer as well as element content attributes of all of the precedent layers, and the like.

In some implementations, the pipeline provides a feedback loop by augmenting thumbs up and thumbs down buttons for each element-oriented graphic design output in a user interface. If the user dislikes an element-oriented graphic design output, the application can ask why and use the user feedback data to improve the AI model(s) 126. A thumbs down click could also prompt the user to indicate whether the element-oriented graphic design output was too bright, too dark, too big, too small, or was assigned the wrong style/object, or the like. In other implementations, the application can retrieve user graphic design preferences data from the user database 128, and adjusts the rejected element-oriented graphic design output based on the user graphic design preferences data. The user database 128 can be implemented on the application services platform 110 in some implementations. In other implementations, at least a portion of the user database 128 are implemented on an external server that is accessible by the prompt construction unit 124.

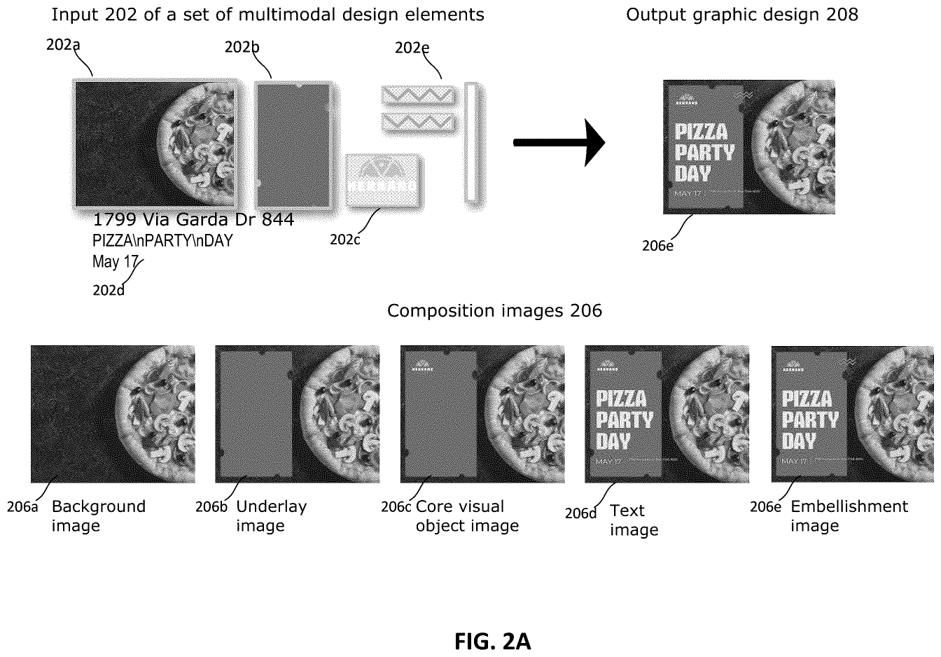

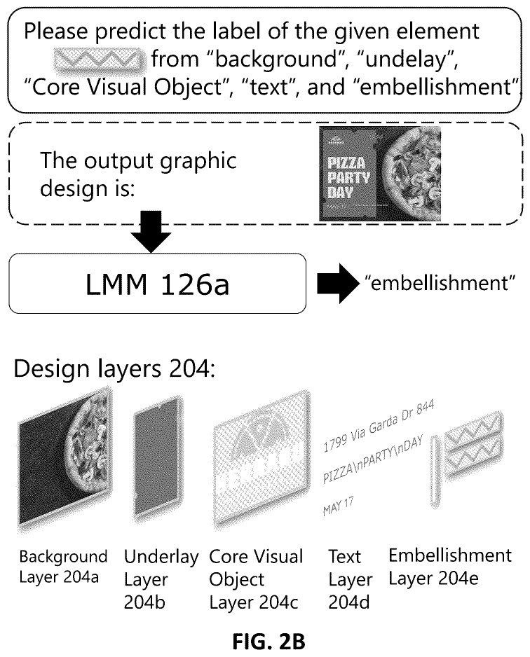

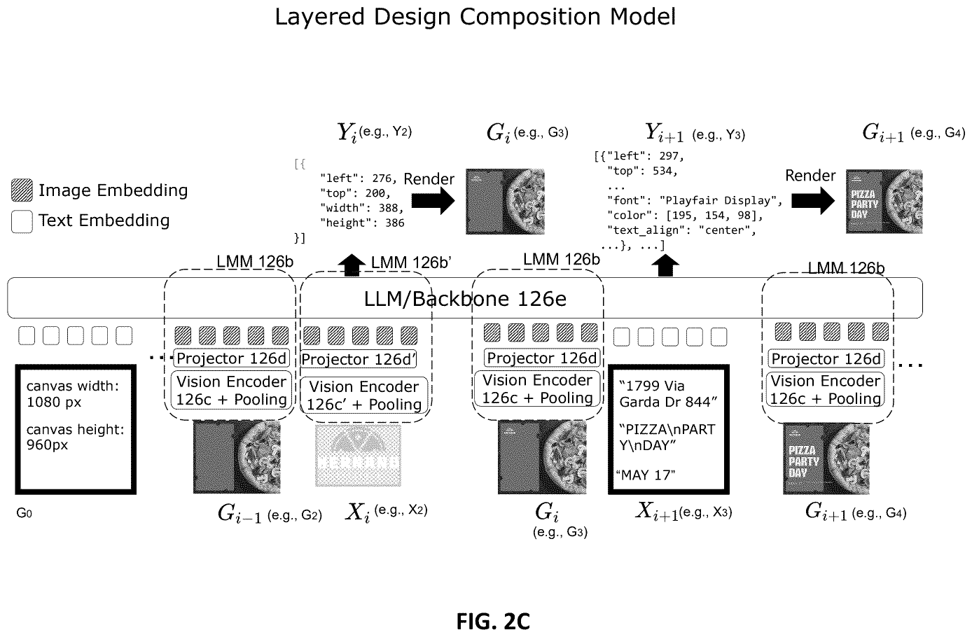

As mentioned, the pipeline starts with the layer planning stage by categorizing input design elements into pre-defined layers. Then, at the layered design composition stage, the pipeline predicts element position and size attributes in a layer-wise manner and gathers them together to get composition images, including the final composition image incorporating complete element content attributes of the full set of input design elements. FIGS. 2A-2C are conceptual diagrams of an AI-based multimodal element-oriented, layered graphic design pipeline of the system of FIG. 1 according to principles described herein.

FIG. 2A depicts an input 202 of a set of multimodal design elements 202a-202e, processed via the layer planning stage to be categorized on each of the layers 204, and via the layered design composition stage to be used to generate composition images 206 that includes an output graphic design 208. The composition images 206 include a background image 206a, an underlay image 206b, a core visual object image 206c, a text image 206d, and an embellishment image 206e.

The pipeline formulates layer planning as an element content understanding problem and leverage pre-trained LMMs to resolve the problem. Specifically, the pipeline employs a pretrained LMM to automatically generate input element labels, thereby achieving layer planning. The first step is to determine a reasonable layer structure using a generative model (e.g., the layer planning LMM 126a) based on a system prompt listed in Table 1. Since text elements can be easily identified by the text attributes, the layer planning LMM 126a focuses on labelling non-text design elements into the other four labels in a zero-shot manner.

In one implementation, the layer planning LMM 126a is GPT-40. When a design element A is an image input into GPT-40, it undergoes a tokenization process where the image is divided into smaller segments, i.e., tiles. Each tile is then represented as a sequence of tokens, such that visual data can be handled in a manner similar to text. For instance, a 512×512 pixel image tile is represented by 170 tokens in GPT-40. Once the image is tokenized, each token is converted into an embedding vector that capture the semantic information of the token. Depending on the semantic information, the design element A is labelled as either a core visual object or an embellishment.

TABLE 1

You are an excellent graphic designer.
Your task is to determine the role of the given
element, which is rendered as an image.
There are 4 possible options:
Background, Underlay, Core Visual Object or
Embellishment. Please refer to the detailed
descriptions below to make your prediction.
Background: The foundational layer of the design,
typically large in size and covering the entire
canvas. It may consist of a solid color, gradient,
landscape image, or similar visual foundation.
Underlay: A supportive layer placed beneath
key content, often used to create contrast or
highlight the main design elements, such as
borders, buttons, color overlays, and so on.
Core Visual Object: A core visual element that
combines both imagery and logo elements to
capture attention and convey the primary message.
It represents a brand, product, or entity.
Embellishment: Decorative elements that enhance
visual appeal without conveying core information.
These elements add style to the design.
Note that they are usually small in size.
When you respond, please output only one word
from the 4 options. Do not include any
additional explanations or irrelevant information.
The element is <image>. Please predict the
given element role:

In Table 1, the pipeline uses five design layers, namely background, underlay, core visual object, text, and embellishment layers in a placement order. This placement order is a result after consulting experienced designers and numerous completed design experiments. The top portion of FIG. 2B depicts that the layer planning LMM 126a determines the label of a given design element (e.g., a green wave in a rectangular box) to be an “embellishment” among “background”, “undelay”, “core visual object”, “text”, and “embellishment.”

Based on the input 202, the layer planning LMM 126a categorizes the design elements as shown in the lower portion of FIG. 2B. There are five design layers, namely a background layer 204a, an underlay layer 204b, a core visual object layer 204c, a text layer 204d, and an embellishment layer 204e in the placement order. The background layer 204a contains an image 202a with a pizza on a black marble countertop. The underlay layer 204b is a red rectangular-cheese-shaped image 202b. The core visual object layer 204c contains one logo 202c of a yellow graphic with white text and a transparent background. The text layer 204d contains three pieces of text 202d “1799 Via Garda Dr 844,” “PIZZA\nPARTY\nDAY,” and “May 17.” The embellishment layer 204e contains three embellishment elements 202e.

In one implementation, the pipeline leverages a pre-trained LMM (e.g., GPT-40) to automatically label the design element input 202 for layer planning. To guide GPT-40 effectively, the pipeline crafted prompts that clearly define the problems and describe the characteristics of each element label, and request the model to output the most appropriate one for input elements. Table 2 lists a prompt for training samples.

The overall design is <image>. The canvas
width is wcanvaspx, canvas height is hcanvaspx.
The element is <image>. The element width is
welementpx, element height is helementpx.
Please also consider the provided canvas and
element width/height, as they might be helpful
in making a decision. Please predict the
given element role.

At the layered design composition stage, the pipeline deploys a layered design composition model that includes design composition LMMs 126b sharing a model backbone. Each design composition LMM 126b consists of three components: a vision encoder 126c, a projector 126d, and the model backbone (e.g., a LLM 126e) as shown in FIG. 2C. The vision encoder 126c encodes the element images and composition images into image embeddings. The projector 126d then projects these embeddings to match a hidden state dimension required by the model backbone. This dimension is the size of the vectors that represent the internal states of the model, encapsulating the information processed at each step. When projecting image embeddings to align with an LLM's hidden state dimension, it is essential to ensure compatibility between the image representation and the LLM's processing capabilities.

The model backbone models a joint distribution across layers, thereby ensuring cohesion in the layered design process. A joint distribution represents the probability distribution of multiple random variables simultaneously, encapsulating the likelihood of various outcomes occurring together. In layered designs, modeling this distribution helps in understanding how variables at different layers interact and influence each other, ensuring that changes in one layer are cohesively reflected in others. By effectively capturing the relationships between variables at different layers, the backbone achieves a harmonious and efficient design.

For example, Llama-3.1-8B, is chosen as the backbone, and CLIP ViT-L/14 model can be used as the vision encoder. The projector can be structured as a two-layer multilayer perceptron (MLP) using Gaussian error linear unit (GELU) activation functions. A two-layer MLP is a type of artificial neural network designed to model complex relationships within data by introducing non-linear transformations. It consists of an input layer, a single hidden layer, and an output layer. This architecture enables the network to learn and represent intricate patterns, making it suitable for tasks such as classification and regression. GELU differs from traditional activation functions by considering the input's value and its probability under a Gaussian distribution, allowing for a more nuanced activation that can improve model performance. A two-layer MLP utilizing GELU activation functions combines the simplicity of a basic neural network architecture with the advanced capabilities of the GELU activation. This combination enables the model to learn complex, non-linear patterns effectively, making it a powerful tool in the field of machine learning.

FIG. 2C depicts the process of applying the a layered design composition model to sequentially render the composition images. Starting from an empty canvas G0 (e.g., 1080×960), the backbone can obtain composition images 206a-206e (i.e., G1-G5), where G1 represents only a composition image of the background layer, G2 represents an composition image of the background layer and the underlay layer, and so forth, with G5 represents a composition image of the complete finalized design of all five layers. For simplification, FIG. 2C only shows composition images 206b-206d (e.g., G2-G4) as examples. The layered structure is not limited to this example, but adjustable for users to add or remove some components as feasible.

The backbone possess understanding capabilities to model the layered design process for multimodal design elements. As shown in FIG. 2C, in the i-th design layer, the backbone predicts the position and size attribute set Yi for current layer's elements Xi. The preceding layers are rendered as a composition image Gi−1 and reintroduced into the backbone to be part of the contextual input, guiding the generation of Yi. The pipeline represents Xi and Yi by concatenating their element content attributes per layer for the current layer, respectively.

To accelerate the processing, another LMM 126b′ (including another vision encoder 126c′ and another projector 126d′) is used to process an element image (e.g., Xi), while the LMM 126b is processing an composition image (e.g., Gi−1) in FIG. 2C, to generate position and size attributes Yi of the element image and render a composition image Gi. For example, the LMM 126b′ processes the logo 202c on the core visual object layer 204c, while the LMM 126b processes the underlay image 206b, in order to generate position and size attributes of the logo 202c and render the core visual object image 206c.

The LMMs 126b, 126b′ are used to process composition images (e.g., Gi−1, Gi, Gi+1) and visual design elements (e.g., Xi being the logo 202c). On the other hand, text elements (e.g., Xi+1 being “1799 Via Garda Dr 844,” etc.) on the text layer 204d can be input to the backbone to get position and size attributes (e.g., Yi+1) of the text elements (e.g., Xi+1), without processing by the LMMs 126b, 126b′. For example, the text embeddings of the text elements “1799 Via Garda Dr 844,” etc. are input into the backbone, while the LMM 126b processes the core visual object image 206c, in order to generate position and size attributes of the text elements and render the text image 206d.

In one implementation, to reduce computational complexity, a pooling operation (e.g., 2D average pooling operation) is applied to the output of the vision encoder 126c that reduces the spatial dimensions of feature maps, thereby effectively compressing the image embeddings and enhancing computational efficiency, before sent to the projector 126d. Average pooling computes the average of all values in the pooling region, providing a smoother representation of the feature map. 2D Average Pooling is a specific application of average pooling tailored for two-dimensional spatial data, such as images. It operates over the height and width dimensions of the input, computing the average within each pooling window and producing a down-sampled output. This method is particularly effective in preserving spatial hierarchies in image data.

The pipeline applies the backbone based on another system prompt listed in Table 3 to generate the composition images 206a-206e. The rendered composition image of previous layers are incorporated in the context for the composition image of the subsequent layers.

```
TABLE 3
conversations″: [
  {
    ″from″: ″human″,
    ″value″: ″a poster of canvas width 800px, canvas_height 618px. element 0: <image0>,
element 1: <image1>, element 2: <image2>, element 3: \″Australia\″, element 4:
\″bushfires\″, element 5: \″2,5K\“. Please predict step by step according to the semantics of
the elements. After each prediction, there will be an intermediate rendering result as a
reference to better make the next prediction.\n\n\nNow predict the background elements:
element 0: <image>″
  },
      >>> LLM prediction at timestamp i
  {
    ″from″: ″human″,
    ″value″: ″current canvas state: <image>. Now predict the underlay elements: element
1: <image>, element 2: <image>″
  },
  >>> LLM prediction at timestamp i+1
  {
    ″from″: ″human″,
    ″value″: ″current canvas state: <image>. Now predict the core visual object elements:
null″
  },
  >>> LLM prediction at timestamp i+2
  {
    ″from″: ″human″,
    ″value″: ″current canvas state: <image>. Now predict the text elements: element 3:
\″Australia\″, element 4: \″bushfires\″, element 5: \″2,5K\″,″
  },
  >>> LLM prediction at timestamp i+3
  {
    ″from″: ″human″,
    ″value″: ″current canvas state: <image>. Now predict the embellishment elements: null″
  },
  >>> LLM prediction at timestamp i+4
],
```

For the background, underlay, core visual object, and embellishment layers, their inputs are visual elements. Hence, Xi is a combination of element images e.g., in pixel values. For example, Table 4 lists Yi for a logo element on the core visual object layer Xi (element 1: <image>). The <image> token is a placeholder which is replaced by image embeddings during data loading. In this logo example, the “left” and “top” attributes define the position of the logo, and the “width” and “height” attributes define the size of the logo.

TABLE 4

{
“index”: 1,
“left”: −78,
“top”: 378,
“width”: 1228,
“height”: 1842
}

For the text layer, text content attributes are concatenated together to construct Xi, while the element attributes are serialized into JSON strings to construct Yi. For example, Table 5 lists Yi for two text elements on the text layer Xi (element 2: Spring Clean, element 3: Best hack). In this logo example, the “left” and “top” attributes define the position of the text element, the “width” and “height” attributes define the size of the text element, and other content attributes define the appearance of the text element.

TABLE 5

| | |
|---|---|
| { | { |
| “index”: 2, | “index”: 3, |
| “left”: 98, | “left”: 272, |
| “top”: 375, | “top”: 547, |
| “width”: 874, | “width”: 537, |
| “height”: 125, | “height”: 68, |
| “angle”: 0, | “angle”: 0, |
| “font”: “Raleway”, | “font”: “Raleway”, |
| “font_size”: 125, | “font_size”: 68, |
| “color”: [29, 29, 27], | “color”: [0, 0, 0], |
| “text_align”: “center”, | “text_align”: “center”, |
| “capitalize”: “false”, | “capitalize”: “false”, |
| “letter_spacing”: 0.0, | “letter_spacing”: 0.0, |
| “line_height”: 1.0, | “line_height”: 1.0 |
| } | } |

When a design layer has no element, Xi is represented as null and Yi is represented as an empty JSON string { }. In one implementation, within each layer, the elements are randomly shuffled to prevent information leakage.

More details are provided regarding how the layered design composition model generates the core visual object image 206c (G3) that incorporates the core visual object layer 204c and its precedent layers 204a, 204b. The vision encoders 126c, 126c′ respectively encode the underlayer image 206b (G2) and the element images of the core visual object layer 204c into image embeddings. After the encoding and the pooling operation, the projectors 126d, 126d′ respectively project these image embeddings to match a hidden state dimension required by the backbone. The backbone then decides, based on the projected image embeddings, the position and size attribute Y2 of the core visual object X2 (e.g., the logo) as “left”: 276, “top”: 200, “width”: 388, “height”: 386.

FIG. 2C also depicts how the layered design composition model generates the text image 206d (G4) that incorporates the text layer 204d and its precedent layers 204a-204c. The text elements of the text layer 204d are text embeddings. The vision encoder 126c encodes the core visual object image 206c (G3) into image embeddings. After the encoding and the pooling operation, the projector 126d projects these image embeddings to match a hidden state dimension required by the. The backbone then decides, based on the text embeddings and the projected image embeddings, the position and size attribute Y3 of the text elements X3 (e.g., “1799 Via Garda Dr 844,” “PIZZA\nPARTY\nDAY,” and “May 17”) as [{“left”: 297, “top”: 534, . . . “font”: “1799 Via Garda Dr 844”, “color”: [195, 154, 98], “text_align”: “center”, . . . }, . . . ].

For training samples of the layered design composition model where ground truth designs are available, the pipeline included the design images and metadata (e.g., canvas size, element size, and the like) into the model input to enhance the prediction accuracy. For efficient training, the pipeline utilized the low-rank adaptation (LoRA) technique on the backbone, jointly optimizing LoRA parameters and the projector while keeping the vision encoder parameters fixed. The LoRA technique efficiently fine-tunes the backbone for specific tasks. Instead of updating all the model's parameters during fine-tuning, which is resource-intensive, LoRA keeps the vision encoder parameters fixed and incorporates trainable low-rank matrices into each layer of the Transformer architecture. This approach significantly reduces the number of parameters that need to be trained, leading to decreased GPU memory usage and faster training times. During training, the pipeline fine-tuned the layered design composition model by minimizing the negative log-likelihood of Yi across all layers using formula (1).

$$ℒ = - {\sum }_{i = 1}^{5} log P ( {Y}_{i} \vert {Y}_{< i} , {X}_{< i} , {G}_{< i} ) \qquad ( 1 )$$

Since all intermediate composition images can be rendered in advance, the training process is parallelized across the five design layers. Compared to generating the whole attributes at once, the pipeline adds only about a 20% increase in rendering time to obtain the intermediate composition images, making it an effective and efficient method.

The layered design composition model offers remarkable flexibility at inference. It can handle other design subtasks without any task-specific training. For example, when the ground truth background image 206a (G1) is provided, and the model is tasked with generating G2 through G5, it can effectively achieve content-aware layout generation. Similarly, when G1 to G3 are given as ground truth, and the model can generate the text image 206d (G4).

FIGS. 3A-3E are diagrams of an example user interface of an AI-based multimodal element-oriented, layered graphic design application that implements the techniques described herein. The example user interface shown in FIGS. 3A-3D is a user interface of an AI-based multimodal element-oriented, layered graphic design application within an AI-based design platform, such as but not limited to Microsoft Designer®. However, the techniques herein for AI-based multimodal element-oriented, layered graphic design are not limited to use in an AI-based design platform and may be used to generate graphic designs for other types of applications including but not limited to graphic design applications, presentation applications, website authoring applications, collaboration platforms, communications platforms, and/or other types of applications in which users create, view, and/or edit various graphic designs based on a given set of multimodal design elements. Such applications can be a mini application in an AI-based design application, a stand-alone application, or a plug-in of any application on the client device 105, such as the browser application 112, the native application 114, and the like. For example, the system can work on the web or within a virtual meeting and collaboration application (e.g., Microsoft Teams®) or an email application (e.g., Outlook®). The system can be integrated into the Microsoft Viva® platform or could work within a browser (e.g., Windows® Edge®). The system can also work within a social media website/application (e.g., Facebook®, Instagram®).

FIG. 3A shows an example of the user interface 305 of an AI-based multimodal element-oriented, layered graphic design application (e.g., Microsoft Designer®) in which the user is interacting with AI generative model(s) to generate different types of images, graphic designs, and the like based on various inputs. The user interface 305 includes a control pane 315, a chat pane 325 and a scrollbar 335. The user interface 305 may be implemented by the native application 114 and/or the browser application 112.

In some implementations, the control pane 315 includes an Assistant button 315a, a Generate button 315b, a Share button 315c, an Edit button 315d, and a search field 315e. The AI-Assistant button 315a can be selected to provide element-oriented, layered graphic design functions as discussed. In some implementations, the chat pane 325 provides a workspace in which the user can enter prompts in the AI-based multimodal element-oriented, layered graphic design application for generating element-oriented, layered graphic designs. In the example shown in FIG. 3A, the chat pane 325 shows at least two mini application tiles 325a and 325b.

The mini application tile 325a represents an image creator and depicts a description of “Create any image you can image-just enter in a text description.” The mini application tile 325a also depicts a prompt enter box over a sample imagine and a “Generate” button. The prompt enter box already shows an sample prompt of “a city with buildings made of colorful candies” over the sample image created by the image creator based on the sample prompt. A user can enter a new prompt in the prompt enter box and then select the ‘Generate’ button to create a new image.

The mini application tile 325b represents a graphic design generator and depicts a description of “Element-oriented graphic design!” The mini application tile 325b also depicts a “Try it!” button. The prompt enter box shows an instruction of “Generate any graphic designs—just drop a set of design elements.”

When the user selects the Generate button 315b, a dropdown list of mini applications is displayed for the user to select. The user can select the graphic design generator to generate element-oriented graphic designs. For example, the user can drop design elements to generate a pizza party invitation. The Share button 315c can be selected to trigger the dropdown list of the mini applications to share the generated content, such as the element-oriented graphic designs. The Edit button 315d can be selected to edit the generated content, such as the element-oriented graphic designs. The search field 315e is for a user to enter a search word, phrase, paragraph, and the like within the content library 142, the requests, prompts, and responses 144, the extracted/inferred user data 146 (e.g., user preferences), the training data 148, and the like. The fields in the AI-based multimodal element-oriented, layered graphic design application can provide auto-fill and/or spell-check functions.

FIG. 3B continues from FIG. 3A upon a selection of the mini application tile 325b by, for example, hovering a cursor over the mini application tile 325b, and/or clicking on any pixel in the mini application tile 325b. In this example, the chat pane 325 shows a prompt enter box 325c with a default instruction of ‘Generate a graphic design based on dragged and dropped design elements,” and several design elements 345a-345f dropped by the user in the chat pane 325. The chat pane 325 shows a field 325d with text elements entered by the user: “1799 Via Garda Dr 844,” “PIZZA\nPARTY\nDAY,” and “May 17.” Upon a user selection of the Generate button 315b, an element-oriented, layered graphic design 345g is output in FIG. 3C based on the above-discussed implementations.

As described, the multimodal element-oriented, layered graphic design pipeline stores the layers placed with design elements (e.g., the layers 204a-204e in FIG. 2B) for editing at a layer level, as well as the intermediate composition images (e.g., the composition 206a-206e in FIG. 2A) for generating the final composition image. When the user selects the Edit button 315d, FIG. 3D shows the chat pane 325 with the prompt enter box 325c having a default instruction of “Edit design elements per layer by deleting, dragging & dropping, or importing other elements,” design layers 355a-355e, the field 325d with a default instruction of “Edit text”, and the field 325e with a default instruction of “Explore other design elements.” For example, upon a user entry of a new text element “birthday party” in the field 325d and a user selection of the Generate button 315b, the system generates another element-oriented, layered graphic design based on the edits. The position and size attributes of the changed design elements are adjusted to suit the canvas size. FIG. 3E shows the chat pane 325 with the prompt enter box 325c having an instruction of “Explore different canvas sizes.” In FIG. 3E, the system generated element-oriented graphic designs 365a-365d of the same input elements with different canvas sizes, thereby making the final designs appealing in various canvas sizes.

In one embodiment, the element-oriented graphic design outputs are saved in the content library 142 in case the same user wants to use the same element-oriented graphic design outputs. The extracted/inferred user data 146 (e.g., user preferences) is tentatively linked with a user ID during a user session and saved in a cache. After the user session, extracted/inferred user data 146 is de-linked form the user ID as metadata of the element-oriented graphic design output and saved in the content library 142. In addition, the extracted/inferred user data 146 linked with the user ID is saved back to the user database 128.

The AI model(s) 126 may be included as part of the application services platform 110 or they may be external models that are called by the application services platform 110. In implementations where other models in addition to the AI model(s) 126 are utilized, those models may be included as part of the application services platform 110 or they may be external models that are called by the application services platform 110.

The request processing unit 122 also coordinates communication and exchange of data among components of the application services platform 110 as discussed in the examples which follow. The request processing unit 122 receives a user request to generate a graphic design with desired style(s) from the native application 114 or the browser application 112.

In some implementations, the application services platform 110 complies with privacy guidelines and regulations that apply to the usage of the user data included in the user database 128 to ensure that users have control over how the application services platform 110 utilizes their data. The user is provided with an opportunity to opt into the application services platform 110 to allow the application services platform 110 to access the user data and enable the AI model(s) 126 to generate graphic designs according to the user's desired style/objects.

The enterprise data storage 140 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

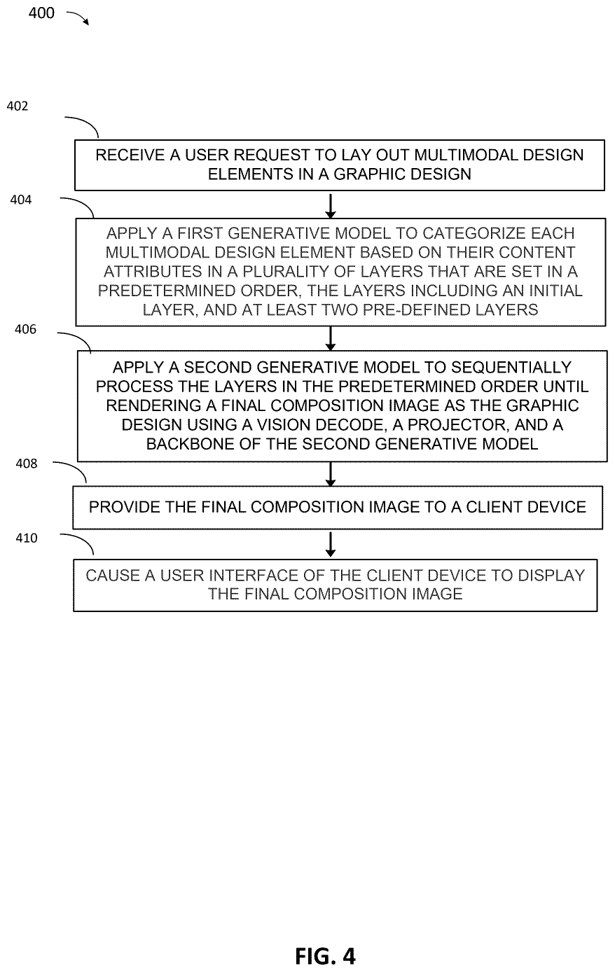

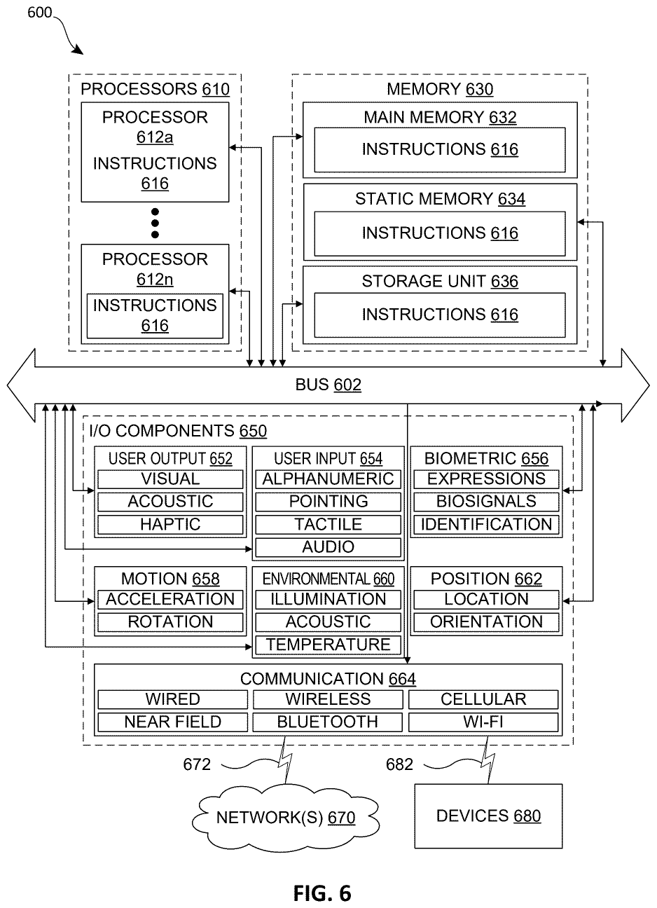

FIG. 4 is a flow chart of an example process 400 for AI-based multimodal element-oriented, layered graphic design according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps. In one implementation, for example, in step 402, a request processing unit (e.g., the request processing unit 122) receives, at a client device (e.g., the client device 105), a user request to lay out multimodal design elements (e.g., the multimodal design elements 202 in FIG. 2A) in a graphic design (e.g., the output graphic design 208 in FIG. 2A).

In step 404, the request processing unit 122 works in conjunction with a prompt construction unit (e.g., the prompt construction unit 124) to apply a first generative model (e.g., the layer planning LMM 126a in FIG. 2B) to categorize each of the multimodal design elements 202 based on content attributes of the multimodal design elements 202 in a plurality of layers that are set in a predetermined order. For example, layers include an initial layer, and at least two pre-defined layers, and the content attributes include at least one of semantic content, color, texture, shapes, font, size, typography, space, or layout. In one implementation, the initial layer is a background layer (e.g., the background layer 204a in FIG. 2B), and the at least two pre-defined layers include an underlay layer (e.g., the underlay layer 204b in FIG. 2B), a core visual object layer (e.g., the core visual object layer 204c in FIG. 2B), a text layer (e.g., the text layer 204d in FIG. 2B), or an embellishment layer (e.g., the embellishment layer 204e in FIG. 2B), as defined by the system (e.g., in a system prompt listed in Table 1) or by a user (e.g., in a user input of definitions of the layers).

In step 406, the request processing unit 122 works in conjunction with the prompt construction unit 124 to apply a second generative model (e.g., the layered design composition model including design composition LMMs sharing a model backbone in FIG. 2C) to sequentially process the layers in the predetermined order until rendering a final composition image (e.g., the embellishment image 206e in FIG. 2A) as the graphic design 208.

A vision encoder (e.g., the vision encoder 126c in FIG. 2C) is applied to encode content attributes of each design element of the initial layer (e.g., the background layer 204a) into initial content embeddings. A projector (e.g., the projector 126d in FIG. 2C) is applied to project the initial content embeddings to match a hidden state dimension required by a backbone (e.g., the backbone in FIG. 2C) of the second generative model. The backbone is applied to predict position and size attributes per design element of the initial layer based on the projected content embeddings. An initial image (e.g., the background image 206a in FIG. 2A) is rendered by placing each design element of the initial layer onto the initial layer based on the position and size attributes predicted for each design element of the initial layer.

In one implementation, a pooling operation is applied onto the initial content embeddings of the initial layer to provide a compressed initial content embeddings of the initial layer, and the projector 126d is applied to project the compressed initial content embeddings of the initial layer to match the hidden state dimension required by the backbone.

For each of the pre-defined layers (e.g., the underlay layer 204b, the core visual object layer the text layer 204d, and the embellishment layer 204e in FIG. 2B), the vision encoder 126c is applied to encode content attributes of each design element of the pre-defined layer and each design element of a precedent image (e.g., the background image 206a) into combined content embeddings, the projector 126d is applied to project the combined content embeddings to match the hidden state dimension required by the backbone 126e, the backbone 126e is applied to predict position and size attributes per design element of the pre-defined layer based on the combined embeddings, and a composition image (e.g., the underlay image 206b) is rendered by placing each design element of the pre-defined layer onto the pre-defined layer (e.g., the underlay layer 204b) based on the position and size attributes predicted for each design element of the pre-defined layer, and overlaying the placed pre-defined layer upon the precedent image as the composition image. The precedent image starts with the initial image.

In one implementation, a pooling operation is applied onto the combined content embeddings of the pre-defined layer to provide a compressed combined content embeddings of the pre-defined layer, and the projector 126d is applied to project the compressed combined content embeddings of the pre-defined layer to match the hidden state dimension required by the backbone 126e.

When a pre-defined layer (e.g., the core visual object layer 204c in FIG. 2B) contains at least one visual object element (e.g., X2 in FIG. 3C), the predicting position and size attributes (e.g., Y2 in FIG. 3C) per design element for the pre-defined layer includes: applying the vision encoder 126c to encode each visual object element of the core visual object layer 204c and each visual object element of the precedent image (e.g., the underlay image 206b in FIG. 2A, or G2 in FIG. 2C) into combined image embeddings, applying the projector 126d to project the combined image embeddings to match the hidden state dimension required by the backbone 126e, applying the backbone 126e to predict position and size attributes per visual object element of the core visual object layer 204c based on the projected combined image embeddings, and rendering a composition image (e.g., the core visual object image 206c in FIG. 2A, or G3 in FIG. 2C) by placing each visual object element of the core visual object layer 204c onto the p core visual object layer 204c based on the position and size attributes predicted for each visual object element of the core visual object layer 204c, and overlaying the placed core visual object layer upon the precedent image as the composition image.

When a pre-defined layer is a text layer (e.g., the text layer 204d in FIG. 2B), the predicting position and size attributes (e.g., Y3 in FIG. 2C) per design element for the text layer 204d includes: converting each text element (e.g., “1799 Via Garda Dr 844,” “PIZZA\nPARTY\nDAY,” and “May 17”, or X3 in FIG. 2C) of the text layer 204d into text embeddings, applying the vision encoder 126c to encode each visual object element of the precedent image (e.g., the core visual object image 206c in FIG. 2A, or G3 in FIG. 2C) into precedent image embeddings, applying the projector 126d to project the precedent image embeddings to match the hidden state dimension required by the backbone 126e, applying the backbone 126e to predict position and size attributes per text element of the text layer 204d based on the text embeddings and the projected precedent image embeddings, and rendering a composition image (e.g., the text image 206d in FIG. 2A, or G4 in FIG. 2C) by placing each text element of the text layer 204d onto the text layer 204d based on the position and size attributes predicted for each text element of the text layer 204d, and overlaying the placed text layer upon the precedent image as the composition image.

In step 408, the request processing unit 122 provides the final composition image to the client device. In step 410, the request processing unit 122 causes a user interface of the client device to display the final composition image. In one implementation, the request processing unit 122 provides one or more of the placed pre-defined layers to the client device, and causes the user interface of the client device to display the one or more of the placed pre-defined layers (e.g., the design layers 355a-355e in FIG. 3D). Upon receiving one or more user edits to at least one of the placed pre-defined layers, the request processing unit 122 renders another final composition image based on the placed pre-defined layers and the one or more user edits, provides the other final composition image to the client device, and causes the user interface of the client device to display the other final composition image.

The system allows users to drag and drop design elements thus simplifying the graphic design process for the users. This ease of use increases user productivity and utilization, as well as attracts more non-technical users who are not trained to enter complicated text prompts. By automating the layout design process, the system eliminates reliance on user-manually-generated detailed layout prompts. This solution significantly lowers the barrier to create high-quality, stylized layouts, and makes the consistent artistic graphic design creation process more efficient and open. The system can apply the consistent artistic layout to multimodal design elements of a range of content types, including text, image objects, images with text, videos, animations, underlays, backgrounds, embellishments, or the like, thereby enhancing the versatility of a graphic design creation platform/application.

Besides, the system also enables some interesting applications in graphic design, such as achieving design compositions of different canvas sizes (“resolution adjustment”), adding new element(s) on an existing design to make it more pleasing (“element filling”), and creating diverse designs based on the same input elements (“design variations”).

In some implementations, the system can apply/share the element-oriented graphic designs immediately, so that the user can celebrate the relevant event (e.g., the user's birthday). Moreover, the comprehensive element-oriented graphic design approach can be a fun and creative way for individuals to add a personal touch to their invitations, cards, personal profiles, and other graphic designs that show and consider all design elements given by a user.

Therefore, the system provides a comprehensive element-oriented, layered graphic design based on a given set of multimodal design elements. The system personalizes the comprehensive element-oriented graphic design outputs for the user. In addition, the system can modify the comprehensive element-oriented graphic design outputs based on user edits per layer.

There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

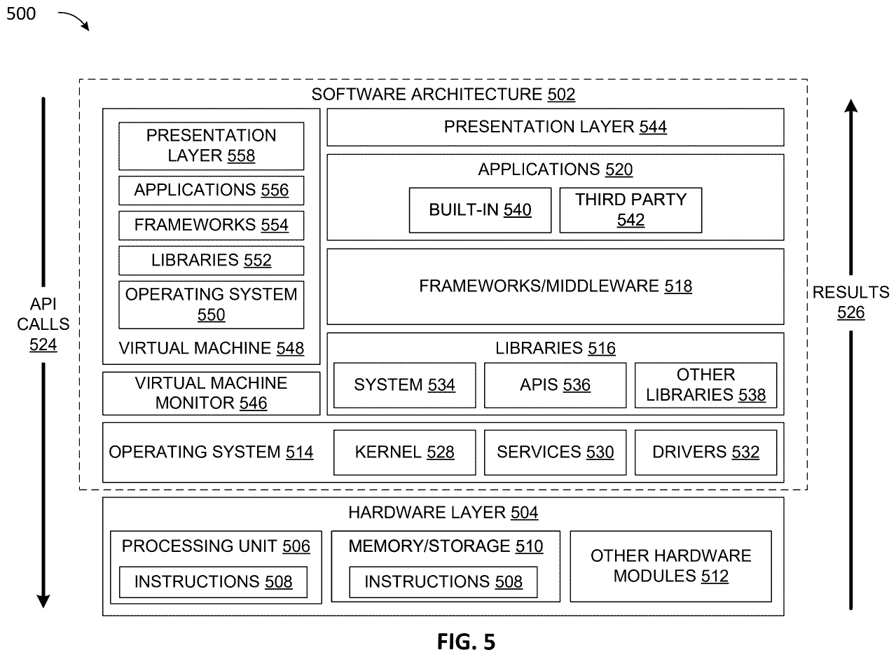

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, and file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IOT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a tensor processing unit (TPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform operations:
receiving, at a client device, a user request to lay out multimodal design elements in a graphic design;
applying a first generative model to categorize each of the multimodal design elements based on content attributes of the multimodal design elements in a plurality of layers that are set in a predetermined order, wherein the layers include an initial layer, and at least two pre-defined layers;
applying a second generative model to sequentially process the layers in the predetermined order until rendering a final composition image as the graphic design, by:
applying a vision encoder to encode content attributes of each design element of the initial layer into initial content embeddings,
applying a projector to project the initial content embeddings to match a hidden state dimension required by a backbone of the second generative model,
applying the backbone to predict position and size attributes per design element of the initial layer based on the projected content embeddings,
rendering an initial image by placing each design element of the initial layer onto the initial layer based on the position and size attributes predicted for each design element of the initial layer,
for each of the pre-defined layers:
applying the vision encoder to encode content attributes of each design element of the pre-defined layer and each design element of a precedent image into combined content embeddings,
applying the projector to project the combined content embeddings to match the hidden state dimension required by the backbone,
applying the backbone to predict position and size attributes per design element of the pre-defined layer based on the combined embeddings, and
rendering a composition image by placing each design element of the pre-defined layer onto the pre-defined layer based on the position and size attributes predicted for each design element of the pre-defined layer, and
overlaying the placed pre-defined layer upon the precedent image as the composition image, wherein the precedent image starts with the initial image;
providing the final composition image to the client device; and
causing a user interface of the client device to display the final composition image.

2. The data processing system of claim 1, wherein the machine-readable storage medium further includes instructions configured to cause the processor alone or in combination with other processors to perform operations of:
providing one or more of the placed pre-defined layers to the client device; and
causing the user interface of the client device to display the one or more of the placed pre-defined layers.

3. The data processing system of claim 2, wherein the machine-readable storage medium further includes instructions configured to cause the processor alone or in combination with other processors to perform operations of:
receiving one or more user edits to at least one of the placed pre-defined layers;
rendering another final composition image based on the placed pre-defined layers and the one or more user edits;
providing the other final composition image to the client device; and
causing the user interface of the client device to display the other final composition image.

4. The data processing system of claim 1, wherein when a pre-defined layer contains at least one visual object element, the predicting position and size attributes per design element for the pre-defined layer includes:
applying the vision encoder to encode each visual object element of the pre-defined layer and each visual object element of the precedent image into combined image embeddings, applying the projector to project the combined image embeddings to match the hidden state dimension required by the backbone, applying the backbone to predict position and size attributes per visual object element of the pre-defined layer based on the projected combined image embeddings, and
rendering a composition image by placing each visual object element of the pre-defined layer onto the pre-defined layer based on the position and size attributes predicted for each visual object element of the pre-defined layer, and overlaying the placed pre-defined layer upon the precedent image as the composition image.

5. The data processing system of claim 4, wherein when a pre-defined layer is a text layer, the predicting position and size attributes per design element for the pre-defined layer includes:
converting each text element of the text layer into text embeddings, applying the vision encoder to encode each visual object element of the precedent image into precedent image embeddings, applying the projector to project the precedent image embeddings to match the hidden state dimension required by the backbone, applying the backbone to predict position and size attributes per text element of the text layer based on the text embeddings and the projected precedent image embeddings, and
rendering a composition image by placing each text element of the text layer onto the text layer based on the position and size attributes predicted for each text element of the text layer, and overlaying the placed text layer upon the precedent image as the composition image.

6. The data processing system of claim 1, wherein the machine-readable storage medium further includes instructions configured to cause the processor alone or in combination with other processors to perform operations of:
applying a pooling operation onto the initial content embeddings of the initial layer to provide a compressed initial content embeddings of the initial layer; and
applying the projector to project the compressed initial content embeddings of the initial layer to match the hidden state dimension required by the backbone.

7. The data processing system of claim 6, wherein the machine-readable storage medium further includes instructions configured to cause the processor alone or in combination with other processors to perform operations of:
applying a pooling operation onto the combined content embeddings of the pre-defined layer to provide a compressed combined content embeddings of the pre-defined layer; and
applying the projector to project the compressed combined content embeddings of the pre-defined layer to match the hidden state dimension required by the backbone.

8. The data processing system of claim 1, wherein the machine-readable storage medium further includes instructions configured to cause the processor alone or in combination with other processors to perform operations of:
receiving a user input of definitions of the at least two pre-defined layers.

9. The data processing system of claim 1, wherein the initial layer is a background layer, and the at least two pre-defined layers include an underlay layer, a core visual object layer, a text layer, or an embellishment layer.

10. The data processing system of claim 1, wherein the content attributes include at least one of semantic content, color, texture, shapes, font, size, typography, space, or layout.

11. A method comprising:
receiving, at a client device, a user request to lay out multimodal design elements in a graphic design;
applying a first generative model to categorize each of the multimodal design elements based on content attributes of the multimodal design elements in a plurality of layers that are set in a predetermined order, wherein the layers include an initial layer, and at least two pre-defined layers;
applying a second generative model to sequentially process the layers in the predetermined order until rendering a final composition image as the graphic design, by:
applying a vision encoder to encode content attributes of each design element of the initial layer into initial content embeddings,
applying a projector to project the initial content embeddings to match a hidden state dimension required by a backbone of the second generative model,
applying the backbone to predict position and size attributes per design element of the initial layer based on the projected content embeddings,
rendering an initial image by placing each design element of the initial layer onto the initial layer based on the position and size attributes predicted for each design element of the initial layer,
for each of the pre-defined layers:
applying the vision encoder to encode content attributes of each design element of the pre-defined layer and each design element of a precedent image into combined content embeddings,
applying the projector to project the combined content embeddings to match the hidden state dimension required by the backbone,
applying the backbone to predict position and size attributes per design element of the pre-defined layer based on the combined embeddings, and
rendering a composition image by placing each design element of the pre-defined layer onto the pre-defined layer based on the position and size attributes predicted for each design element of the pre-defined layer, and
overlaying the placed pre-defined layer upon the precedent image as the composition image, wherein the precedent image starts with the initial image;
providing the final composition image to the client device; and
causing a user interface of the client device to display the final composition image.

12. The method of claim 11, further comprising:
providing one or more of the placed pre-defined layers to the client device; and
causing the user interface of the client device to display the one or more of the placed pre-defined layers.

13. The method of claim 12, further comprising:
receiving one or more user edits to at least one of the placed pre-defined layers;
rendering another final composition image based on the placed pre-defined layers and the one or more user edits;
providing the other final composition image to the client device; and
causing the user interface of the client device to display the other final composition image.

14. The method of claim 11, wherein when a pre-defined layer contains at least one visual object element, the predicting position and size attributes per design element for the pre-defined layer includes:
applying the vision encoder to encode each visual object element of the pre-defined layer and each visual object element of the precedent image into combined image embeddings, applying the projector to project the combined image embeddings to match the hidden state dimension required by the backbone, applying the backbone to predict position and size attributes per visual object element of the pre-defined layer based on the projected combined image embeddings, and
rendering a composition image by placing each visual object element of the pre-defined layer onto the pre-defined layer based on the position and size attributes predicted for each visual object element of the pre-defined layer, and overlaying the placed pre-defined layer upon the precedent image as the composition image.

15. The method of claim 14, wherein when a pre-defined layer is a text layer, the predicting position and size attributes per design element for the pre-defined layer includes:
converting each text element of the text layer into text embeddings, applying the vision encoder to encode each visual object element of the precedent image into precedent image embeddings, applying the projector to project the precedent image embeddings to match the hidden state dimension required by the backbone, applying the backbone to predict position and size attributes per text element of the text layer based on the text embeddings and the projected precedent image embeddings, and
rendering a composition image by placing each text element of the text layer onto the text layer based on the position and size attributes predicted for each text element of the text layer, and overlaying the placed text layer upon the precedent image as the composition image.

16. A non-transitory computer readable medium on which are stored instructions that, when executed, cause a programmable device to perform functions of:
receiving, at a client device, a user request to lay out multimodal design elements in a graphic design;
applying a first generative model to categorize each of the multimodal design elements based on content attributes of the multimodal design elements in a plurality of layers that are set in a predetermined order, wherein the layers include an initial layer, and at least two pre-defined layers;
applying a second generative model to sequentially process the layers in the predetermined order until rendering a final composition image as the graphic design, by:
applying a vision encoder to encode content attributes of each design element of the initial layer into initial content embeddings,
applying a projector to project the initial content embeddings to match a hidden state dimension required by a backbone of the second generative model,
applying the backbone to predict position and size attributes per design element of the initial layer based on the projected content embeddings,
rendering an initial image by placing each design element of the initial layer onto the initial layer based on the position and size attributes predicted for each design element of the initial layer,
for each of the pre-defined layers:
applying the vision encoder to encode content attributes of each design element of the pre-defined layer and each design element of a precedent image into combined content embeddings,
applying the projector to project the combined content embeddings to match the hidden state dimension required by the backbone,
applying the backbone to predict position and size attributes per design element of the pre-defined layer based on the combined embeddings, and
rendering a composition image by placing each design element of the pre-defined layer onto the pre-defined layer based on the position and size attributes predicted for each design element of the pre-defined layer, and
overlaying the placed pre-defined layer upon the precedent image as the composition image, wherein the precedent image starts with the initial image;
providing the final composition image to the client device; and
causing a user interface of the client device to display the final composition image.

17. The non-transitory computer readable medium of claim 16, wherein the instructions when executed, further cause the programmable device to perform:
providing one or more of the placed pre-defined layers to the client device; and
causing the user interface of the client device to display the one or more of the placed pre-defined layers.

18. The non-transitory computer readable medium of claim 17, wherein the instructions when executed, further cause the programmable device to perform:
receiving one or more user edits to at least one of the placed pre-defined layers;
rendering another final composition image based on the placed pre-defined layers and the one or more user edits;
providing the other final composition image to the client device; and
causing the user interface of the client device to display the other final composition image.

19. The non-transitory computer readable medium of claim 16, wherein when a pre-defined layer contains at least one visual object element, the predicting position and size attributes per design element for the pre-defined layer includes:
applying the vision encoder to encode each visual object element of the pre-defined layer and each visual object element of the precedent image into combined image embeddings, applying the projector to project the combined image embeddings to match the hidden state dimension required by the backbone, applying the backbone to predict position and size attributes per visual object element of the pre-defined layer based on the projected combined image embeddings, and
rendering a composition image by placing each visual object element of the pre-defined layer onto the pre-defined layer based on the position and size attributes predicted for each visual object element of the pre-defined layer, and overlaying the placed pre-defined layer upon the precedent image as the composition image.

20. The non-transitory computer readable medium of claim 19, wherein when a pre-defined layer is a text layer, the predicting position and size attributes per design element for the pre-defined layer includes:
converting each text element of the text layer into text embeddings, applying the vision encoder to encode each visual object element of the precedent image into precedent image embeddings, applying the projector to project the precedent image embeddings to match the hidden state dimension required by the backbone, applying the backbone to predict position and size attributes per text element of the text layer based on the text embeddings and the projected precedent image embeddings, and
rendering a composition image by placing each text element of the text layer onto the text layer based on the position and size attributes predicted for each text element of the text layer, and overlaying the placed text layer upon the precedent image as the composition image.
